(19) United States
(12) Patent Application Publication
(10) Pub. No.: US 2026/0161554 A1
(43) Pub. Date: Jun. 11, 2026

(54) MANAGING STORAGE SPACE OF APPLICATION

(71) Applicant: Beijing Zitiao Network Technology Co., Ltd., Beijing (CN)

(72) Inventor: Yongkang DONG, Beijing (CN)

(21) Appl. No.: 19/348,705

(22) Filed: Oct. 2, 2025

(30) Foreign Application Priority Data
Dec. 5, 2024 (WO) PCT/CN2024/137044

(51) Int. Cl. G06F 12/02

(52) U.S. Cl. CPC G06F 12/0253

(57) ABSTRACT

Methods, apparatuses, devices, and media for managing storage space of an application are provided. In one method, an application is executed in a computing device that includes a request statement used to apply for a local object, the local object occupies at least a part of storage space in the computing device that is available to the application. A difference between the size of the local object and the size of the unoccupied space in the storage space is determined. In response to determining that the difference satisfies the predetermined condition, an exception handling process is invoked at the computing device, the exception handling process includes a release process for releasing the occupied space in the storage space. With implementations of the present disclosure, a release process at a computing device may be triggered by an application.

### CROSS-REFERENCE

This application claims the benefit of priority of International Patent Application No. PCT/CN2024/137044, filed on Dec. 5, 2024, and entitled “METHOD, APPARATUS, DEVICE AND MEDIUM FOR MANAGING STORAGE SPACE OF APPLICATION”, the entirety of which is incorporated herein by reference.

### FIELD

Implementations of the present disclosure generally relate to application management, and in particular, to managing storage space of an application.

### BACKGROUND

At present, applications for executing a plurality of tasks have been developed, and in an application running process, storage space of a computing device may be occupied. The computing device may manage its own storage space, and perform a garbage collection (GC) process in order to release the occupied part in the storage space when the storage space is insufficient. However, the application cannot control execution of garbage collection, which results in a response delay of the application due to insufficient available storage space during running process of the application. At this time, it is desirable to manage the storage space occupied by the application in a more efficient manner, thereby improving the performance of the application.

### SUMMARY

In a first aspect of the present disclosure, a method for managing storage space of an application is provided. In the method, an application is executed in a computing device, the application comprises a request statement used to apply for a local object, the local object occupies at least a part of storage space available to the application in the computing device. A difference between a size of the local object and a size of unoccupied space in the storage space is determined. An exception handling process is invoked at the computing device in response to determining that the difference satisfies a predetermined condition, the exception handling process comprises a release process for releasing occupied space in the storage space.

In a second aspect of the present disclosure, an apparatus for managing storage space of an application is provided. The apparatus comprises: an executing module configured to execute an application in a computing device, the application comprises a request statement used to apply for a local object, the local object occupies at least a part of storage space available to the application in the computing device; a determining module configured to determine a difference between a size of the local object and a size of unoccupied space in the storage space; and an invoking module configured to invoke an exception handling process at the computing device in response to determining that the difference satisfies a predetermined condition, the exception handling process comprising a release process for releasing occupied space in the storage space.

In a third aspect of the present disclosure, an electronic device is provided. The electronic device comprises: at least one processor; and at least one memory coupled to the at least one processor and storing instructions for execution by the at least one processor, the instructions, when executed by the at least one processor, causing the electronic device to perform the method according to the first aspect of the present disclosure.

In a fourth aspect of the present disclosure, there is provided a computer-readable storage medium storing computer instructions thereon, the computer instructions upon exection by a processor, causing the processor to implement the method according to the first aspect of the present disclosure.

In a fifth aspect of the present disclosure, there is provided a computer program product, comprising a computer program, where the computer program upon exection by a processor, implementing the method according to the first aspect of the present disclosure.

It should be understood that the content described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

In the following text, the above and other features, advantages, and aspects of the various implementations of the present disclosure will become more apparent from the following detailed description taken in conjunction with the accompanying drawings. In the drawings, the same or similar reference numbers refer to the same or similar elements, where:

FIG. 1 illustrates a block diagram of an application environment according to an implementation of the present disclosure;

FIG. 2 illustrates block diagram for managing storage space of an application according to some implementations of the present disclosure;

FIG. 3 illustrates a block diagram for applying for a local object in a loop manner according to some implementations of the present disclosure;

FIG. 4 illustrates a block diagram for applying for a local object based on an upper limit of storage space according to some implementations of the present disclosure;

FIG. 5 illustrates a flowchart of a method for managing storage space of an application according to some implementations of the present disclosure;

FIG. 6 illustrates a block diagram of an apparatus for managing storage space of an application according to some implementations of the present disclosure; and

FIG. 7 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “comprising” and similar terms should be understood to include “comprising but not limited to”. The term “based on” should be understood as “at least partially based on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the obtaining or use of the data) should follow the requirements of the corresponding laws and regulations and related provisions.

It may be understood that, before the technical solutions disclosed in the embodiments of the present disclosure are used, the types, the usage scope, the usage scenario and the like of personal information related to the present disclosure should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use the personal information of the user. Therefore, the user may autonomously select whether to provide personal information to software or hardware, such as an electronic device, application, server, or storage medium, etc., executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notifying and obtaining a user authorization process is merely illustrative, and does not constitute a limitation on implementations of the present disclosure, and other manners of meeting related laws and regulations may also be applied to implementations of the present disclosure.

The term “in response to” as used herein represents a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

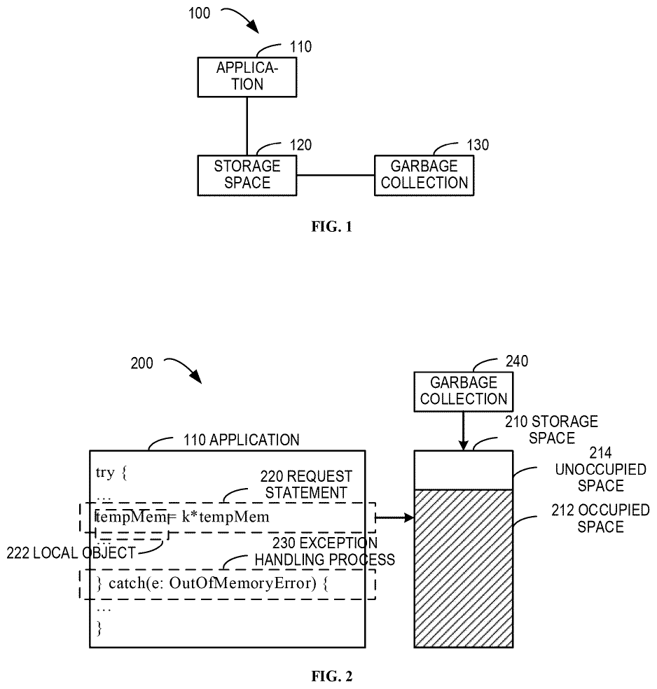

At present, applications for executing a plurality of tasks have been developed, and in an application running process, storage space of a computing device may be occupied. Referring to FIG. 1 to describe an application environment according to some implementations of the present disclosure, here FIG. 1 illustrates a block diagram 100 of an application environment according to some implementations of the present disclosure. As shown in FIG. 1, the application 110 may be deployed to the computing device, and during running process of the application 110, the application 110 may occupy the storage space 120 of the computing device. The storage space 120 may include, for example, storage space in a memory of the computing device.

The computing device may manage its own storage space 120, and when the storage space is insufficient, garbage collection 130 may be executed in order to release the occupied space in the storage space 120. However, application 110 cannot control the execution of the garbage collection. The response delay of the application due to insufficient available storage space may occur during running process of the application. At this time, it is desirable to manage the storage space occupied by the application in a more efficient manner, thereby improving the performance of the application.

### Summary of Application Management

In order to at least partially solve the deficiencies in the prior art, according to an implementation of the present disclosure, a method for managing storage space of an application is provided. Referring to FIG. 2 to describe a summary of an implementation of the present disclosure, here FIG. 2 illustrates a block diagram of storage space for managing an application according to some implementations of the present disclosure. As shown in FIG. 2, a method for managing storage space of an application is provided. Specifically, the application 110 may be executed in the computing device, and the application 110 may include a request statement 220 used to apply for a local object 222. Here, the local object 222 may occupy at least a part of the storage space 210 in the computing device that is available to the application. In FIG. 2, the storage space 210 may include occupied space 212 and unoccupied space 214.

During the execution of the application 110, the application 110 may allocate space for the local object 222 from the unoccupied space 214. At this time, the size of the unoccupied space 214 becomes smaller, and the size of the occupied space 212 becomes larger. As the application is executed, the storage space 210 is gradually occupied. A difference between the size of the local object 220 and the size of the unoccupied space in the storage space 210 may be determined, and an exception handling process may be invoked at the computing device in response to determining that the difference satisfies the predetermined condition. Here, the exception handling process 230 may trigger a release process (e.g., garbage collection 240) for releasing the occupied space in the storage space.

With implementations of the present disclosure, a release process at a computing device may be triggered by an application. In this way, the garbage collection for storage space may be triggered in a stable and reliable manner, unnecessary occupied storage space may be released, and the size of the available storage space of the application is increased, thereby improving the response speed of the application.

### Detailed Process of Application Management

Having described a summary according to some implementations of the present disclosure, more details will be described below regarding the method for managing storage space of the application. For ease of description, the application implemented in the Java environment is used as only an example to describe the process of managing the storage space of the application. Alternatively and/or additionally, the code of the application may be written in a development environment supporting other languages, thereby completing more implementations of managing the storage space of the application. In the Java environment, the Java Virtual Machine (JVM) is one of the core components of the Java language, which is an abstract virtual machine and may run the Java program. The main role of JVM is to provide a running environment, enabling Java programs to run on different operating systems and hardware platforms.

In a Java environment, the storage space may be, for example, space occupied by a Java heap. A Java heap is a very important memory area in the Java virtual machine for storing instances of objects. The heap is one of the largest memory areas in the JVM, and is also the main management area of the garbage collector. Instances of objects created in Java applications and the like may be stored in the Java heap. Since a large number of objects are stored in the heap, the garbage collector needs to periodically clean objects that are no longer used to release the memory. When the Java program creates new objects, the JVM may allocate memory for these objects in the heap. This process is typically automatic, controlled by the JVM's memory management mechanism.

According to some implementations of the present disclosure, the garbage collection may be triggered by an application. Specifically, the request statement may be located in an exception handling portion of the application. With continued reference to FIG. 2, for example, in a Java environment, the request statement 220 may be written into the exception handling code segment “try { . . . }”. One example of a request statement may include, for example, “tempMem=k*tempMem”. It should be understood that “tempMem” may represent a name of a local object, and other names may be set according to a naming rule in Java, for example, “tempValue”, “tempParameter”, and the like. It should be understood that the local object is valid only inside the exception handling code segment. “k” may represent a predefined real number, for example, a specific value of “k” may be set to 1, 1.5, or 2, and so on. According to some implementations of the present disclosure, the local object may have any specified format, for example, including but not limited to an integer, a floating point, a string, an array, a class, or any other format.

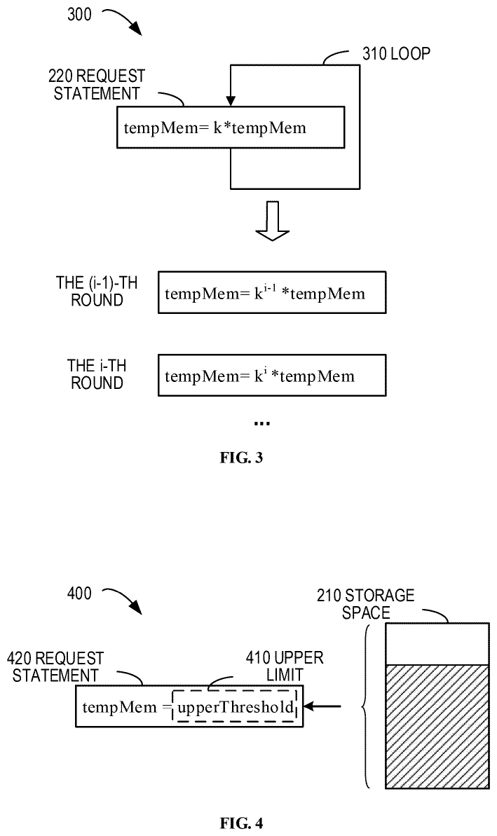

According to some implementations of the present disclosure, the request statement may be repeatedly executed. Referring to FIG. 3 for more details, FIG. 3 shows a block diagram 300 of applying for a local object in a loop manner according to some implementations of the present disclosure. As shown in FIG. 3, the request statement 220 may be continuously executed in the loop 310, assuming k=1.5, then the space occupied by the local object in each round will become 1.5 times of the space occupied by the local object in the previous round. In this way, huge memory exceeding the upper limit of Java may be gradually applied, thereby triggering the garbage collection. In other words, the size of the local object will increase with the increased round. At this time, the size of the local object increases as the request statement is repeatedly executed. With some implementations of the present disclosure, the size of the local object may be continuously increased, and the time point for triggering the garbage collection process may be determined in a controllable manner.

According to some implementations of the present disclosure, the number of rounds that the request statement is to be repeatedly executed may be specified, for example, it may be specified that N times will be repeated. For example, the number of rounds that the request statement will be repeatedly executed may be determined based on the size of the storage space 210, the size of the local object, and the coefficient k. In particular, N may be set to a larger value in order to ensure that during a certain round, the storage space 210 no longer includes enough unoccupied storage space available for being allocated to the local object. Alternatively and/or additionally, the request statement may be repeatedly executed in an infinite loop, at which point the request statement will be continuously executed until the storage space 210 no longer includes enough unoccupied storage space available for being allocated to the local object, and exceptions are thrown out.

According to some implementations of the present disclosure, the size of the local object in the current round is directly proportional to the size of the local object in the previous round, and the previous round is before the current round. Still referring to FIG. 3, in the (i−1)^{th} round, the size of the local object is kⁱ⁻¹ times of the initial size; in the i^{th} round, the size of the local object is kⁱ times of the initial size. That is, the size of the local object in the i^{th} round is k times of the size of the local object in the (i−1)^{th} round. It should be understood that the request statement 220 above is merely an example, and alternatively and/or additionally, the size of the local object in the kⁱ round may be determined based on other formulas. For example, the size of the local object in the current round i may be determined based on the product of the round i and the initial size of the local object.

According to some implementations of the present disclosure, an exception handling process may be invoked at the computing device based on the following manner. Specifically, in response to determining that the difference satisfies the predetermined condition, an exception message indicating that an exception occurs in the storage space is provided; and the exception message is processed by the virtual machine in the computing device, so as to release the occupied space in the storage space. Specifically, the exception message may include “OutOfMemoryError”, and the exception handling process may be defined in the Catch code segment of the application. In this way, the virtual machine in the computing device may be automatically triggered to process the problem of insufficient memory.

According to some implementations of the present disclosure, the storage space occupied by the local object may be increased by a factor of k each time in the loop process until the size of the occupied space exceeds the upper limit of the storage space. At this time, the JVM will throw out an exception “OutOfMemoryError”. Before executing the Catch code segment, the JVM will automatically execute the operations set at the checkpoint to check whether to trigger the garbage collection process. If it is determined that the unoccupied space in the storage space is not enough, the thrown exception will be received by the Catch code segment, thereby automatically triggering the garbage collection process.

Alternatively and/or additionally, the request statement 220 may be executed in a non-loop manner. According to some implementations of the present disclosure, the size of the local object may be set based on the size of the storage space. Further details are described with reference to FIG. 4, here FIG. 4 illustrates a block diagram 400 of applying a local object based on an upper limit of storage space according to some implementations of the present disclosure. As shown in FIG. 4, an upper limit 410 (e.g., represented as usperThreshold) of the storage space 210 may be determined.

Specifically, a local object may be defined in the try code segment, and the size of the local object may be set to the upper limit 410. In this case, the request statement 420 may directly apply for a local object with a size of an upper limit of the storage space 210. The request statement 420 may result in insufficient storage space and the JVM will throw an exception of “OutOfMemoryError”. Before executing the Catch code segment, the JVM will automatically execute the operations set at the checkpoint to check whether to trigger the garbage collection process. If it is determined that the unoccupied space in the storage space is not enough, the thrown exception will be received by the Catch code segment, thereby automatically triggering the garbage collection process.

According to some implementations of the present disclosure, the methods described above may be performed at different time points during application execution process. For example, the method may be performed directly at an early stage of application startup. Specifically, in response to determining that the application is started, the method described above may be performed. In this way, the garbage collection process may be directly invoked by force after the application is started, thereby releasing memory occupation and accelerating the response speed of the application. Alternatively and/or additionally, in response to determining that the size of the unoccupied space in the storage space in the computing device satisfies the threshold condition, the method described above is performed. Specifically, the threshold condition may be any pre-specified condition, for example, may specify that the method described above is performed when the unoccupied space is less than a certain proportion (for example, 50% or another value). In this way, the garbage collection process in the computing device may be triggered when it is discovered that the response speed of application may fall, thereby improving the available storage space of the application and improving the response speed of the application.

According to some implementations of the present disclosure, an application may launch multiple threads. In multiple threads, the main thread may provide the primary function of the application, and the child thread may complete the auxiliary function in the application. The method described above may be performed in a child thread. Since the performance and response speed of the application depend mainly on the main thread, and the execution of the method described above in the child thread does not significantly affect the performance and response speed of the application. In this way, the garbage collection process can be automatically triggered without affecting the normal operation of the application as much as possible, thereby providing more available storage space for normal operation of the application.

With implementations of the present disclosure, a release process at a computing device may be triggered by an application. In this way, garbage collection for storage space may be triggered in a stable and reliable manner, unnecessary occupied storage space is released, and the size of the available storage space of the application is increased, thereby improving the response speed of the application.

### Example Processes

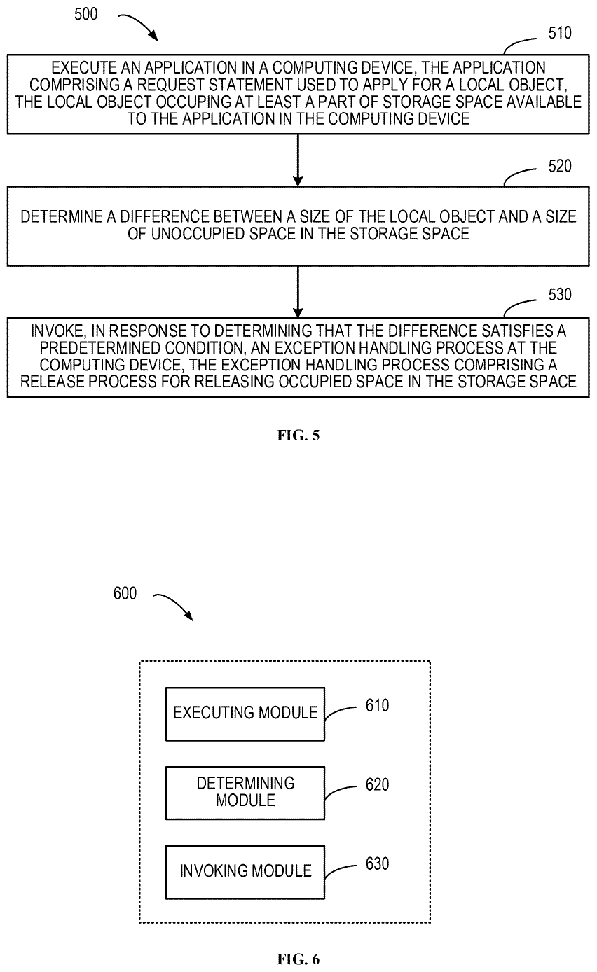

FIG. 5 illustrates a flowchart of a method 500 for managing storage space of an application according to some implementations of the present disclosure. At block 510, an application is executed in a computing device, the application comprises a request statement used to apply for a local object, the local object occupies at least a part of storage space available to the application in the computing device. At block 520, a difference between a size of the local object and a size of unoccupied space in the storage space is determined. At block 530, in response to determining that the difference satisfies a predetermined condition, an exception handling process is invoked at the computing device, the exception handling process comprises a release process for releasing occupied space in the storage space.

According to some implementations of the present disclosure, the request statement is located in an exception handling portion of the application.

According to some implementations of the present disclosure, the request statement is repeatedly executed.

According to some implementations of the present disclosure, the size of the local object increase with a round that the request statement is repeatedly executed.

According to some implementations of the present disclosure, a size of the local object in a current round is directly proportional to a size of the local object in a previous round before the current round.

According to some implementations of the present disclosure, the size of the local object is set based on the size of the storage space.

According to some implementations of the present disclosure, the method further comprises: in response to determining that the application is started, performing the method.

According to some implementations of the present disclosure, the method further comprises: in response to determining that a size of unoccupied space in the storage space in the computing device satisfies a threshold condition, performing the method.

According to some implementations of the present disclosure, invoking the exception handling process at the computing device comprises: providing, in response to determining that the difference satisfies the predetermined condition, an exception message indicating that an exception occurs in the storage space; and processing, by a virtual machine in the computing device, the exception message to release occupied space in the storage space.

### Example Apparatus and Device

FIG. 6 illustrates a block diagram of an apparatus 600 for managing storage space of an application according to some implementations of the present disclosure. The apparatus comprises: an executing module 610 configured to execute an application in a computing device, the application comprises a request statement used to apply for a local object, the local object occupies at least a part of storage space available to the application in the computing device; a determining module 620 configured to determine a difference between a size of the local object and a size of unoccupied space in the storage space; and an invoking module 630 configured to invoke an exception handling process at the computing device in response to determining that the difference satisfies a predetermined condition, the exception handling process comprises a release process for releasing occupied space in the storage space.

According to some implementations of the present disclosure, the request statement is located in an exception handling portion of the application.

According to some implementations of the present disclosure, the request statement is repeatedly executed.

According to some implementations of the present disclosure, the size of the local object increase with a round that the request statement is repeatedly executed.

According to some implementations of the present disclosure, a size of the local object in a current round is directly proportional to a size of the local object in a previous round before the current round.

According to some implementations of the present disclosure, the size of the local object is set based on the size of the storage space.

According to some implementations of the present disclosure, the apparatus is invoked in response to determining that the application is started.

According to some implementations of the present disclosure, the apparatus is invoked in response to determining that a size of unoccupied space in the storage space in the computing device satisfies a threshold condition.

According to some implementations of the present disclosure, the invoking module is further configured to: provide, in response to determining that the difference satisfies the predetermined condition, an exception message indicating that an exception occurs in the storage space; and process by a virtual machine in the computing device, the exception message to release occupied space in the storage space.

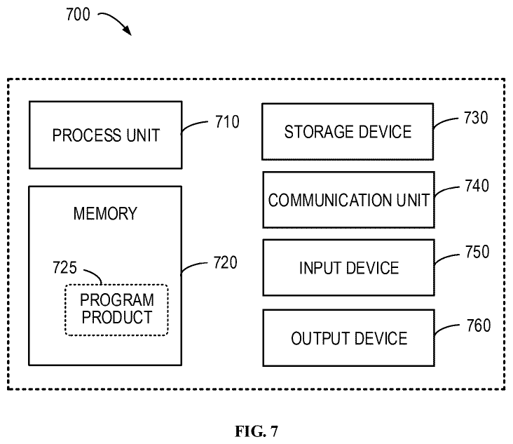

FIG. 7 illustrates a block diagram of a device 700 capable of implementing various implementations of the present disclosure. It should be understood that the computing device 700 shown in FIG. 7 is merely exemplary and should not constitute any limitation on the functionality and scope of the implementations described herein. The computing device 700 shown in FIG. 7 may be configured to implement the method described above.

As shown in FIG. 7, the computing device 700 is in the form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of computing device 700.

Computing device 700 typically includes a plurality of computer storage medium. Such medium may be any available medium accessible by the computing device 700, including, but not limited to, volatile and non-volatile medium, removable and non-removable medium. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data (e.g., training data for training) and may be accessed within computing device 700.

The computing device 700 may further include additional removable/non-removable, volatile/non-volatile storage medium. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data medium interfaces. The memory 720 may include a computer program product 725 having one or more program modules configured to perform various methods or actions of various implementations of the present disclosure.

The communication unit 740 implements communications with other computing devices through a communications medium. Additionally, the functionality of components of the computing device 700 may be implemented in a single computing cluster or multiple computing machines capable of communicating over a communication connection. Thus, the computing device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. Computing device 700 may also communicate with one or more external devices (not shown) through the communication unit 740 as needed, external devices such as storage devices, display devices, etc., communicate with one or more devices that enable a user to interact with computing device 700, or communicate with any device (e.g., network card, modem, etc.) that enables computing device 700 to communicate with one or more other computing devices. Such communication may be performed via an input/output (I/O) interface (not shown).

According to an implementation of the present disclosure, there is provided a computer-readable storage medium having computer-executable instructions stored thereon, where the computer-executable instructions are executed by a processor to implement the method described above. According to an implementation of the present disclosure, a computer program product is further provided, the computer program product being tangibly stored on a non-transitory computer-readable medium and including computer-executable instructions, and the computer-executable instructions being executed by a processor to implement the method described above. According to an implementation of the present disclosure, a computer program product is provided, where a computer program is stored thereon, and when the program is executed by a processor, the foregoing method is implemented.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/actions specified in one or more blocks of the flowchart and/or block diagram. These computer-readable program instructions may also be stored in a computer-readable storage medium that cause the computer, programmable data processing apparatus, and/or other devices to function in a particular manner, such that the computer-readable medium storing instructions includes a manufactured product including instructions to implement aspects of the functions/actions specified in one or more blocks of the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/actions specified in one or more blocks of the flowchart and/or block diagram.

The flowchart and block diagrams in the drawings show architecture, functionality, and operation possibly implement by systems, methods, and computer program products according to various implementations of the present disclosure. In this regard, each block in the flowchart or block diagram may represent a module, program segment, or portion of an instruction that contains one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles and practical applications of the implementations, or improvements to techniques in the marketplace, or to enable others of ordinary skill in the art to understand the various implementations disclosed herein.

1. A method for managing storage space of an application, comprising:
executing an application in a computing device, the application comprising a request statement used to apply for a local object, the local object occupying at least a part of storage space available to the application in the computing device;
determining a difference between a size of the local object and a size of unoccupied space in the storage space; and
invoking, in response to determining that the difference satisfies a predetermined condition, an exception handling process at the computing device, the exception handling process comprising a release process for releasing occupied space in the storage space.

2. The method of claim 1, wherein the request statement is located in an exception handling portion of the application.

3. The method of claim 1, wherein the request statement is repeatedly executed.

4. The method of claim 3, wherein the size of the local object increase with a round that the request statement is repeatedly executed.

5. The method of claim 4, wherein a size of the local object in a current round is directly proportional to a size of the local object in a previous round before the current round.

6. The method of claim 1, wherein the size of the local object is set based on the size of the storage space.

7. The method of claim 1, further comprising: in response to determining that the application is started, performing the method.

8. The method of claim 1, further comprising: in response to determining that a size of unoccupied space in the storage space in the computing device satisfies a threshold condition, performing the method.

9. The method of claim 1, wherein invoking the exception handling process at the computing device comprises:
providing, in response to determining that the difference satisfies the predetermined condition, an exception message indicating that an exception occurs in the storage space; and
processing, by a virtual machine in the computing device, the exception message to release occupied space in the storage space.

10. An electronic device, comprising:
at least one processor; and
at least one memory coupled to the at least one processor and storing instructions for execution by the at least one processor, the instructions upon exection by the at least one processor, causing the electronic device to perform acts comprising:
executing an application in a computing device, the application comprising a request statement used to apply for a local object, the local object occupying at least a part of storage space available to the application in the computing device;
determining a difference between a size of the local object and a size of unoccupied space in the storage space; and
invoking, in response to determining that the difference satisfies a predetermined condition, an exception handling process at the computing device, the exception handling process comprising a release process for releasing occupied space in the storage space.

11. The electronic device of claim 10, wherein the request statement is located in an exception handling portion of the application.

12. The electronic device of claim 10, wherein the request statement is repeatedly executed.

13. The electronic device of claim 12, wherein the size of the local object increase with a round that the request statement is repeatedly executed.

14. The electronic device of claim 13, wherein a size of the local object in a current round is directly proportional to a size of the local object in a previous round before the current round.

15. The electronic device of claim 10, wherein the size of the local object is set based on the size of the storage space.

16. The electronic device of claim 10, further comprising: in response to determining that the application is started, performing the acts.

17. The electronic device of claim 10, further comprising: in response to determining that a size of unoccupied space in the storage space in the computing device satisfies a threshold condition, performing the acts.

18. The electronic device of claim 10, wherein invoking the exception handling process at the computing device comprises:
providing, in response to determining that the difference satisfies the predetermined condition, an exception message indicating that an exception occurs in the storage space; and
processing, by a virtual machine in the computing device, the exception message to release occupied space in the storage space.

19. A non-transitory computer-readable storage medium storing computer instructions thereon, the computer instructions upon exection by a processor, causing the processor to implement acts comprising:
executing an application in a computing device, the application comprising a request statement used to apply for a local object, the local object occupying at least a part of storage space available to the application in the computing device;
determining a difference between a size of the local object and a size of unoccupied space in the storage space; and
invoking, in response to determining that the difference satisfies a predetermined condition, an exception handling process at the computing device, the exception handling process comprising a release process for releasing occupied space in the storage space.

20. The non-transitory computer-readable storage medium of claim 19, wherein the request statement is located in an exception handling portion of the application.
